(19) United States
(12) Patent Application Publication
(10) Pub. No.: US 2005/0149743 A1
(43) Pub. Date: Jul. 7, 2005

(54) Arrangements and methods for secure data transmission

(76) Inventor: Siebren Josephus Schaafsma, Breda (NL)

Correspondence Address: ERICSSON INC., 6300 LEGACY DRIVE, M/S EVR C11, PLANO, TX, 75024, US

(21) Appl. No.: 10/509,724

(22) PCT Filed: Apr. 4, 2002
(86) PCT No.: PCT/NL02/00220

(51) Int. Cl. H04L 9/32; H04N 7/167

(52) U.S. Cl. 713/189

(57) ABSTRACT

A sender (10) arranged to transmit a content file (11) to a receiver (40) where in said sender (10) is arranged to divide said content file (11) in a firs part (22) and a second part (15), to send said first data part (22) to said receiver (40), to encrypt said second part (15), to render an encrypted part and, then, send said encrypted part to said receiver (40).

### FIELD OF THE INVENTION

The invention relates to a sender arranged to transmit a content file to a receiver.

### BACKGROUND

The invention is specifically applicable in fields where caching memories are used. Caching memories are frequently used in network systems in order to achieve a faster and more efficient data transmission. Data much in request is stored in a part of the memory that is easily accessible. This part of the memory is called a cache memory. In case of a network, the cache memory can be positioned remote from the server, preferably closer to an end-user. It is also possible to use more than one cache memory, that can be positioned parallel to each other and/or in a hierarchical structure, as can be seen in FIG. 1.

FIG. 1 shows a server 10 storing data in a memory (not shown). The server 10 comprises also a processor (not shown) connected to the memory for storing data in and reading data from the memory. The server 10 is arranged to communicate with one or more cache servers 20 with cache memories to store data As shown, one or more of the cache servers 20 may be arranged to communicate with further cache servers 30 located close to the end-users. The further cache servers 30 are also comprising cache memories for storing data.

Each of the further cache servers 30 are arranged to communicate with one or more terminals 40 of end-users.

Although all connections in FIG. 1 are shown as physical connections, one or more of these connections can be made wireless. They are only intended to show that “connected” units are arranged to communicate with one another in someway.

The contents of a cache memory can be permanent, but can also be non-permanent and changing constantly depending on the data requested by the terminals 40.

Such a cache mechanism can be used if a data stream has to be distributed to a large number of terminals 40. The data can be cached and as a result of that, distributed easily and quickly to the terminals 40.

However, when such a known caching mechanism is used, every terminal 40 receives exactly the same data. This makes it impossible to watermark and/or encrypt the data for each terminal 40 individually in order to protect the content from piracy.

Watermarking data is done in order to protect the data against illegal distribution. The watermark makes it possible to trace down the origin of the data.

Encrypting data is done when the data is only intended for a certain group of users that possesses a key to decrypt the data. However, when such a key is distributed to a large number of users, it is easily stolen. Thus, there is a clear need for watermarking and encrypting the data individually for each end-user.

Individually encrypting and/or watermarking the data for each terminal could be done at different levels in the network. When it is done in the server 10, it is impossible to use the cache servers 20, 30 since via that route it is not feasible to direct data streams to predetermined users and not to others. Moreover, then the data transfer will be slow and inefficient. Encrypting and/or watermarking can also be performed in the further cache servers 30. However, this would raise the need for intelligent further cache servers 30. This would be an expensive solution all cache servers 30 should be modified for every watermark and/or encryption technique. Further on, the encryption uses capacity, slowing down the overall performance of the network.

### SUMMARY OF THE INVENTION

Therefore, there is a need for an individual secure transmission of data from an originating communication unit to one or more terminals of end users without too much overloading a communication network in between.

In order to obtain this object, the invention provides a system as defined in the outset, wherein said sender is arranged to
divide said content file in a first part and a second part,
send said first data part to said receiver,
encrypt said second part to render an encrypted part and, then,
send said encrypted part to said receiver.

The invention further relates to a receiver arranged to
receive a first part of a content file from a sender and an encrypted part of said content file,
to decrypt said encrypted part to render a second part of said content file,
to assemble said content file from said first and second parts.

The invention further relates to a method of transmitting a content file from a sender to a receiver wherein
said method comprises the following operations:
   dividing said content file in a first part and a second part,
   sending said first data part to the receiver,
   encrypting said second part to render an encrypted part,
   sending said encrypted part to said receiver.

The invention further relates to a method performed by a receiver comprising the following operations:
receiving a first part of a content file,
receiving an encrypted part of said content file,
decrypting said encrypted part to render a second part of said content file,
assembling said content file from said first and second parts.

The invention further relates to a computer program product to be loaded by a sender to provide said sender with the capacity of transmitting a content file to a receiver wherein
said computer program product provides said sender also with the capacity of:
   dividing said content file in a first part and a second part,
   sending said first data part to the receiver,
   encrypting said second part to render an encrypted part,
   sending said encrypted part to said receiver.

The invention further relates to a computer program product to be loaded by a receiver to provide said receiver with the following capacity:
receiving a first part of a content file,
receiving an encrypted part of said content file,
decrypting said encrypted part to render a second part of said content file,
assembling said content file from said first and second parts.

The invention makes it possible to send individually encrypted and/or watermarked data to one or more desired terminals while a low level of additional functionality for a sender and possibly used cache servers is required. The invention can be used for all types of servers, encryption and/or watermarking techniques.

### BRIEF DESCRIPTION OF THE DRAWINGS

The invention will be explained with reference to some drawings which are only intended to illustrate the present invention and not to limit its scope which is only limited by the appended claims.

FIG. 1 shows an example of a network with cache servers for providing data streams to end-users;

FIG. 2 shows a schematic example of a network architecture and data flow according to a first embodiment of the invention;

FIG. 3 shows a schematic example of a network architecture and data flow according to a second embodiment of the invention;

FIG. 4 shows an implementation of a terminal as a personal computer.

FIG. 5a shows a schematic example of a network architecture according to a third embodiment of the invention,

FIG. 5b shows a schematic example of a network architecture according to a fourth embodiment of the invention,

FIG. 6 shows a schematic example of a network architecture according to a fifth embodiment of the invention.

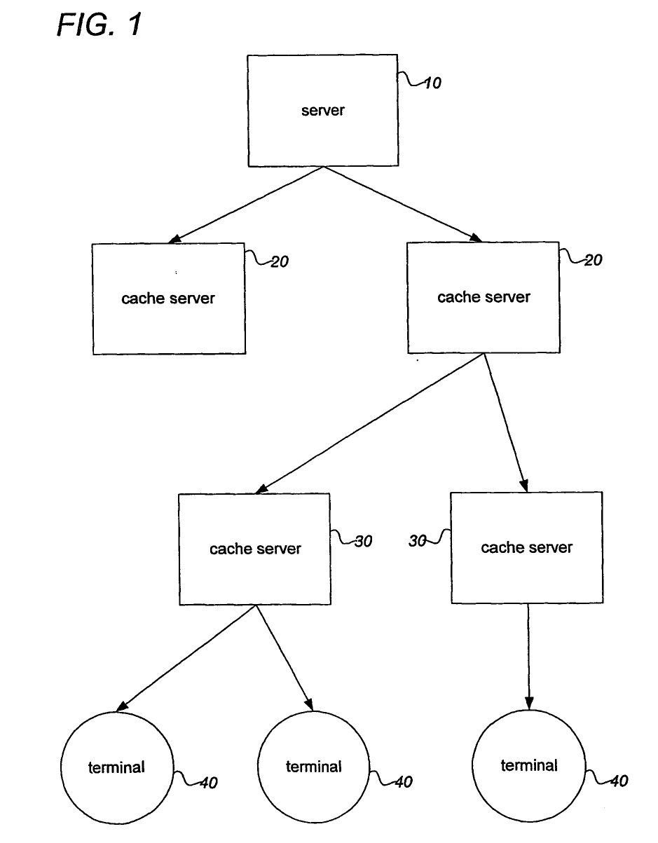

### DESCRIPTION

For the purpose of teaching the invention, preferred embodiments of the method and devices of the invention are described in the sequel. It will be apparent for the person skilled in the art that other alternative and equivalent embodiments of the invention can be conceived and reduced to practice without departing from the true spirit of the invention, the scope of the invention being only limited by the annexed claims.

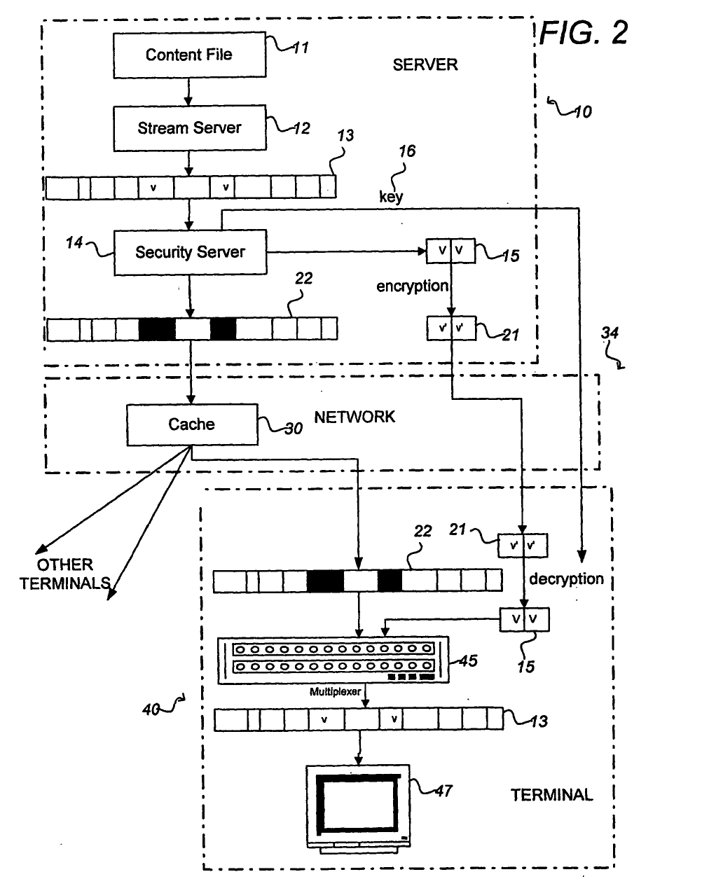

FIG. 2 shows a schematic example of a network architecture comprising a server 10, a network 34 and a terminal 40, where the objective of the network architecture is to transport a content file 11 from the server 10 to the terminal 40. The server 10 comprises a stream server 12 and a security server 14, but the stream server 12 and the security server 14 could also be one physical server.

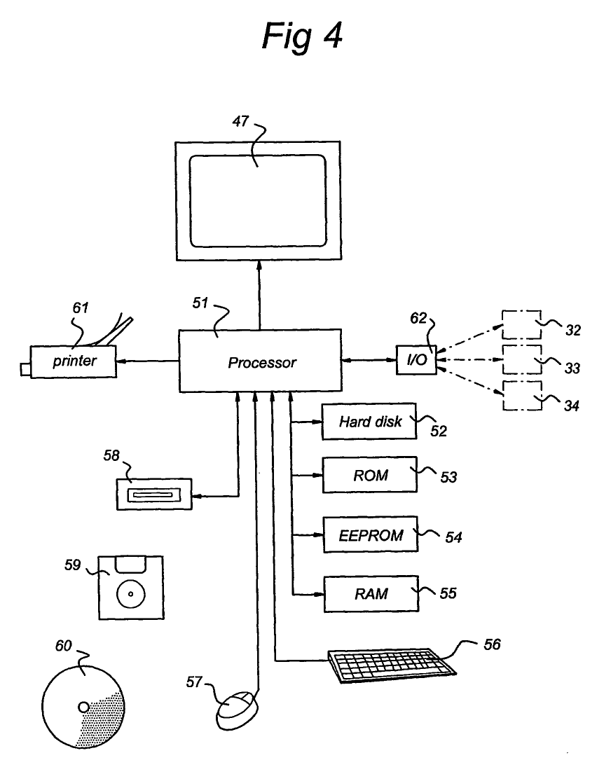

It is emphasized that FIG. 2 only shows an example. The server 10 may comprise one or more processors, different types of memories, like RAM, ROM, EEPROM, hard disk, tape, etc., and all kinds of components to input data/instructions by operators keyboard, mouse, trackball, etc.) and to output data (monitor, printer, floppy disk, etc.). They are not shown in the figures but may be present where required, as is known to persons skilled in the art. Moreover, it is observed that similar components may be present, where required in the cache servers 20, 30 and the terminals 40 of the endusers (cf. FIG. 4).

The server 10 is connected with a network 34, comprising at least one cache server 30. The network 34 is connected with at least one terminal 40, but possibly many others. The terminal 40 comprises e.g. a multiplexer (MUX) 45 and a reproducing device for reproducing the content file 11, for instance a monitor or television 47. However, this reproducing device could also be a computer arrangement, an audio-player or the like. The content file 11 can also be part of a streaming operation or any other known file transport protocol and is handled accordingly by the terminal 40. I.e., it can be a stream (RTP=Realtime Transport Protocol) since the data of the content file 11 may be “consumed” by the terminal 40 without ever being stored completely.

In accordance with the invention, the bulk of the data is sent to the terminal 40 via the cache server 30, however a small, but vital part of the information is sent in an encrypted and/or watermarked form directly and individually to the terminal 40 via the network 34, without using cache server 30.

The content file 11 is prepared for streaming by the stream server 12, indicated in FIG. 2 as streamed data 13. The security server 14 selects portions of the streamed data 13 that are vital for the content file 11 and that are, e.g., crucial for reproducing the content file 11 by terminal 40. The selected portions are indicated with “v” in FIG. 2. Together they form vital data 15. The term “vital” is used here to indicate that the streamed data 13 without the vital data 15 may be reproduced by a terminal 40 later, but will result in at least a distorted reproduced data stream that is unpleasant to sense by an observer.

In case the content file 11 contains music, the vital data 15 could be all data within a certain frequency range. Without the data in this frequency range the music sounds, e.g., differently and deformed.

The vital data 15 could also be the first 10 msec of every second. Leaving these parts out of the music will result in disturbing taps in a reproduced audio signal.

In case the content file 11 contains a movie or a sport game, the security server 14 could filter, e.g., out high frequencies. This will, after reproducing the content file 11 by terminal 40 without the high frequencies, result in e.g. a ball game in which fast moving elements, such as the ball, are filtered out.

The streamed data 13 without the vital data 15 is called the bulk of the data 22. The vital data 15 after encryption is called the encrypted vital data 21. The encryption can be done individually for each terminal or can be done differently for each group of terminals.

In case the data stream consists of two or more parallel streams, such as audio and video, one stream could be used as vital data 15.

It is also possible to arrange the security server in such a way that it selects parts for encryption and/or watermarking randomly, although it is preferred to select vital data that disturbs play back of the content file 11 the most.

In an embodiment, the bulk of the data 22 can for example account for 90%-99% of the total data.

The bulk of the data 22 is sent to the terminal 40 via the cache server 30. It is shown that this part of the data is received by one terminal 40, but in principal many terminals may receive it. The encrypted vital data 21 however, is sent to the terminal 40 directly through network 34.

Moreover a key 16 is sent to the terminal 40 necessary for successfully decrypting the encrypted vital data 21. The key 16 may be transmitted by any known encryption technique in order to guarantee a secure transmission.

Both the encrypted vital data 21 and the key 16 are individually sent to each terminal 40, enabling the server 10 to give each terminal 40 an individual key or watermark.

As a result of the individual character of the transport there is no need to use a cache server 30 for transmitting the key 16 and the encrypted vital data 21. Because the encrypted vital data 21 is only a relatively small part of the content file 11, the reduction in the total transmission efficiency as a result of sending part of the data without the use of cache server 30 is also relatively small.

In FIG. 2, the encrypted vital data 21 and the key 16 are sent to the terminal 40 via the same network 30 as the bulk of the data 22.

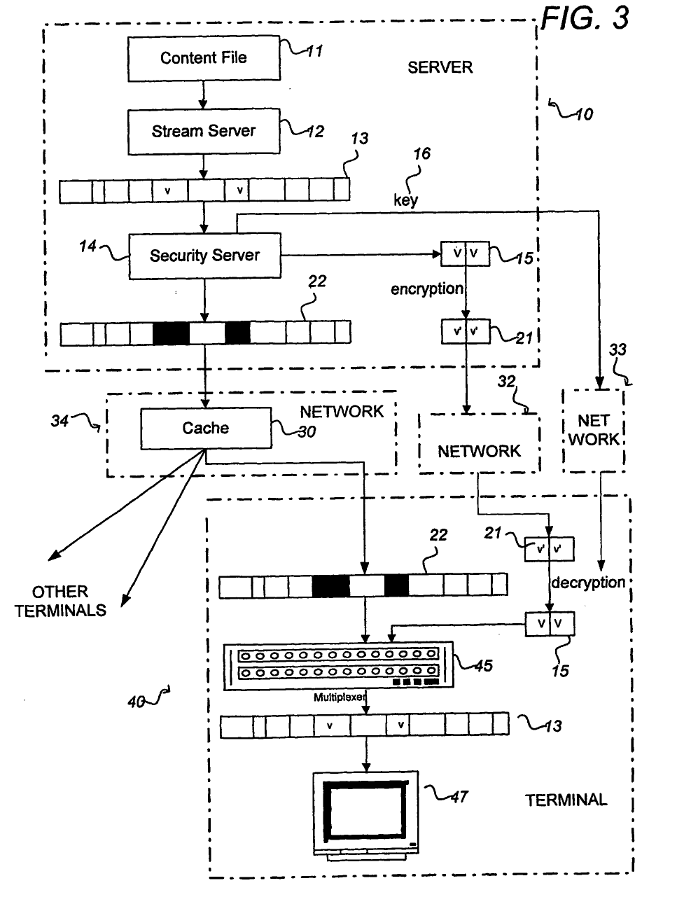

However, in FIG. 3 a second embodiment of the invention is shown in which the bulk of the data 22, the encrypted vital data 21 and the key 16 are each send to the terminal 40 via a different network, respectively a first 34, a second 32 and a third network 33.

This first, second and third network 34, 32, 33 could be the internet, intranet or any other communication network.

The third network 33 could also be a Short Message Service network, the postal services or any other network suitable for sending information. For some purposes, the key 16 only needs to be send to the terminal 40 once and can be used for different content files 11.

The key 16 could also be implemented in a decoder located at the terminal 40. Then the key 16 is sent only once when the decoder is installed.

The key 16 can be one and the same key 16 for all users, or could be different for all users or different for different groups of users. The key 16 could also be changing at certain points of time.

The terminal 40 decrypts the received encrypted vital data 21 with the aid of the key 16 to render vital data 15. The bulk of the data 22 and the vital data 15 are put together by the MUX 45 to render the original streamed data 13 that are sent to, for instance, the monitor 47.

At the terminal 40 the different data streams can be buffered in order to overcome discontinuities in reception as is known to persons skilled in the art.

It is observed that terminal 40 has been shown in a very schematic way. E.g., the functions “MUX” and “decryption” have been shown only schematically. All (or part of) the functionality of the terminal 40 can be implemented by a processor and a memory storing a computer program with proper instructions and data as is known to persons skilled in the art. Some functions may, alternatively, be implemented by dedicated hardware.

An implementation of terminal 40 as a personal computer is shown in FIG. 4, comprising processor means 51 for performing arithmetical operations. The processor means 51 are connected to memory units that store instructions and data, such as a hard disk 52, a Read Only Memory (ROM) 53, Electrically Erasable Programmable Read Only Memory (EEPROM) 54 and a Random Access Memory (RAM) 55. The processor means 51 are also connected to one or more input devices, such as a keyboard 56 and a mouse 57, one or more output devices, such as a display 47 and a printer 61, and one or more reading units 59 to read for instance floppy disks 59 or CD ROM's 60.

However, it should be understood that there may be provided more and/or other memory units, input devices and read devices known to persons skilled in the art. Moreover, one or more of them may be physically located remote from the processor means 51, if required. The processor means 51 are shown as one box, however, they may comprise several processing units functioning in parallel or controlled by one main processor, that may be located remote from one another, as is known to persons skilled in the art.

The processor means Si are also connected to an input/output device 62. This input/output device is arranged to communicate with the network 32, 33, 34.

The memory units 52, 53, 54, 55 can be used to store incoming data for creating a buffer in order to overcome discontinuities in reception as is known to persons skilled in the art.

The memory units 52, 53, 54, 55 can also be loaded with program instructions for reproducing the content file II from the received bulk of the data 22 and the vital encrypted data 21. These program instructions can be imported by means of the input devices, such as the keyboard 17 and the mouse 18 or by means of the reading device 19, that imports the information from a floppy disk 20 or a CD ROM 21.

It is observed that, although all connections in FIG. 4 are shown as physical connections, one or more of these connections can be made wireless. They are only intended to show that “connected” units are arranged to communicate with one another in someway.

The personal computer is shown as a computer system, but can be any signal processing system with analog and/or digital and/or software technology arranged to perform the functions discussed here.

In the embodiments discussed above the functionality is mainly concentrated in the server 10 and the terminal 40. However, those skilled in the art will easily recognize other possible applications of the invention. Two embodiments of those other applications will be discussed below, in which the functionality is mainly concentrated in a sender 10 and a receiver 40, where the sender 10 is arranged to send the content file 11 to the receiver 40.

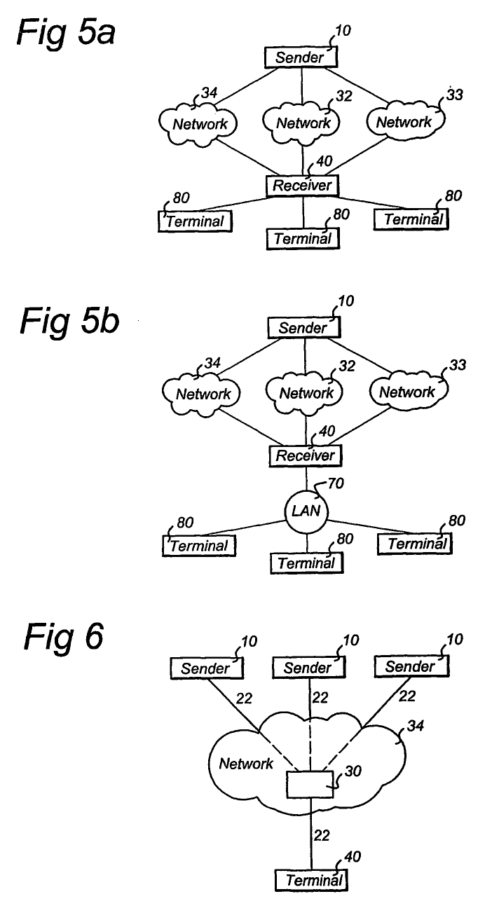

FIGS. 5a and 5b show two other possible embodiments of the invention. FIG. 5a shows a sender 10 that is arranged to communicate with a receiver 40 via different networks 34, 32, 33. The receiver 40 is arranged to communicate with terminals 80. FIG. 5b shows the same components as FIG. 5a, except that receiver 40 is arranged to communicate with the terminals 80 via a Local Area Network (LAN) 70.

In both these embodiments the content file 11 is divided and encrypted in the sender 10. This can be done in a similar way as in the embodiments discussed above. The bulk of the data 22, the encrypted vital data 21 and the key 16 are all sent to the receiver 40, each via different networks 34, 32 and 33. Of course the bulk of the data 22, the encrypted vital data 21 and the key 16 can also be sent via one network 34 as was already discussed in the previous embodiments referring to FIGS. 2 and 3. The receiver 40 receives the bulk of the data 22, the encrypted vital data 21 and the key 16 to render the original content file 13 (not shown in FIGS. 5a and 5b). In contrary to the embodiments discussed above, the receiver 40 can transmit the content file 13 to further receivers that can be terminals 80 or cache servers or a like. Sending to further terminals 80 can be done directly, as is shown in FIG. 5a, or via a network, for instance a LAN 70, as is shown in FIG. 5b.

The receiver 40 can be a cache memory to enhance the distribution of the data to further receiver, such as the terminals 80. This can be useful if, for instance, a company wants to transmit the original content file 13 to a large amount of users, for instance employees of that company, that are all allowed to use the content file 11.

The embodiments shown in FIGS. 5a and 5b can be used to send the data through an unsecure part of the network 30.

FIG. 6 shows a terminal 40 that is arranged to communicate with a first, a second and a third sender 10 via network 34 comprising cache server 30, where said first, second and third senders 10 may use the same or different encryption and/or watermark techniques. The data transport mechanisms and protocols may however be the same. Because decryption is not done in the cache server 30, but in each terminal 40, the single cache server 30 can be used for different encryptions and/or watermark techniques as used by the first, second and third sender 10.

The sending of the vital data 15 and the key 16 is not shown in this figure, but can be done as described above. Analogously to the embodiment shown in FIG. 3, also more than one network 34 may be used. The vital data 15 and the key 16 may be transported via different networks 32, 33.

Analogously to the embodiment shown in FIGS. 5a and 5b, the terminal 40 may also be arranged to communicate with further terminals, directly or via a network 70.

A few embodiments are discussed above, but it will be apparent to those skilled in the art that other embodiments and applications of the invention are conceivable. The above description is not intended to have any limiting effect on the scope of the invention, which is only limited by the annexed claims.

1-20. (canceled)

21. A sender for transmitting a content file to a receiver, said sender comprising:
means for dividing the content file into a first part and a second part;
means for sending the first part to the receiver via at least one cache server;
means for encrypting the second part without using the at least one cache server; and
means for sending the encrypted second part to the receiver.

22. The sender of claim 21, further comprising means for sending the encrypted second part via a different network than the first part.

23. The sender of claim 21, wherein said encrypted second part comprises vital data of said content file.

24. The sender of claim 21, wherein the first part comprises video data and the encrypted second part comprises audio data, or the first part comprises audio data and the encrypted second part comprises video data.

25. The sender of claim 21, wherein said sender is arranged to transmit said content file using a streaming protocol.

26. The sender of claim 21, wherein encrypted data in the encrypted second part comprises predetermined frequency components of the content file.

27. A telecommunication system comprising:
a sender, wherein the sender comprises:
means for dividing a content file into a first part and a second part;
means for sending the first part to the receiver via the at least one cache server;
means for encrypting the second part without using the at least one cache server; and
means for sending the encrypted second part to the receiver;
at least one communication network; and
at least one cache server.

28. The telecommunication system of claim 27, further comprising at least one receiver arranged for communicating with said sender via the at least one cache server and for communicating with said sender without using a cache server.

29. The telecommunication system of claim 28, wherein said at least one cache server is arranged for communicating with more than one sender, said more than one sender using the same or different encryption.

30. The telecommunication system of claim 28, wherein said at least one cache server is arranged for communicating with more than one sender, said more than one sender using watermark techniques.

31. A method of transmitting a content file from a sender to a receiver wherein said method comprises the following operations:
dividing the content file into a first part and a second part;
sending the first part to the receiver via at least one cache server;
encrypting the second part without using the at least one cache server; and
sending the encrypted second part to the receiver.

32. The method of claim 31, further comprising
sending the encrypted second part via a different network than the first part.

33. The method of claim 31, wherein said encrypted second part comprises vital data of said content file.

34. The method of claim 21, wherein the first part comprises video data and the encrypted second part comprises audio data, or the first part comprises audio data and the encrypted second part comprises video data.

35. The method of claim 21, further comprising
sending said content file using a streaming protocol.

36. The sender of claim 21, wherein encrypted data in the encrypted second part comprises predetermined frequency components of the content file.

37. A computer program product in a computer usable medium, for transmitting a content file from a sender to a receiver wherein said computer program product comprises:
instructions for dividing the content file into a first part and a second part;
instructions for sending the first part to the receiver via at least one cache server;
instructions for encrypting the second part without using the at least one cache server; and
instructions for sending the encrypted second part to the receiver.
